(19) United States
(12) Patent Application Publication
(10) Pub. No.: US 2003/0172375 A1
(43) Pub. Date: Sep. 11, 2003

(54) Wireless network and PDA system for sporting events

(76) Inventors: Norman S. Shaw, Memphis, TN (US); Robert S. Roaten, Memphis, TN (US); Jason B. Ziegler, Memphis, TN (US)

Correspondence Address: Intellectual Property Group, Bose McKinney & Evans LLP, 2700 First Indiana Plaza, 135 North Pennsylvania Street, Indianapolis, IN, 46204, US

(21) Appl. No.: 10/385,309

(22) Filed: Mar. 10, 2003

Related U.S. Application Data
(60) Provisional application No. 60/362,948, filed on Mar. 8, 2002.

(51) Int. Cl. H04N 7/16; H04H 9/00; G06F 3/00; H04N 5/445; G06F 13/00; H04N 7/173

(52) U.S. Cl. 725/9; 725/6; 725/50; 725/132; 725/140

(57) ABSTRACT

A method for providing data to a plurality of people in a captive audience during an event comprises providing a limited range wireless network, renting a plurality of PDA devices to a plurality of people attending the event, loading software into the plurality of PDA devices to permit the PDA devices to receive data from the wireless network, transmitting data to the plurality of rented PDA devices from the wireless network during the event, and collecting the plurality of PDA devices after the event.

This application claims the benefit of U.S. Provisional Application Serial No. 60/362,948, filed Mar. 8, 2002, which is expressly incorporated by reference herein.

### BACKGROUND AND SUMMARY OF THE INVENTION

The present invention relates to an apparatus and method for providing information to people in a captive audience, such as at a live sporting event, via a wireless computer network.

The marriage of sports and technology is long and successful. Innovations brought about by technology include better equipment, better record-tracking, better reporting, and better production. A sports fan at home is treated to more information than he can digest from sources including cable TV, satellite TV, the Internet, the printed word, and radio.

But despite all the information available to the fan at home, nothing beats the experience of live sports. The National Football League continues to attract more than 60 million fans annually. NASCAR has become the fastest-growing sport in the world over the past three years. Major League Baseball attracts an average of more than 31,000 people for each game it plays.

What is missing for the more than 200 million fans who fill the stands each year for the NASCAR/Busch, Indy Car/CART, NBA, NFL, MLB, NHL, and collegiate basketball and football is the volume of information they have access to at home. The present invention provides a limited range wireless network and PDA system for delivery of information to individuals at live sporting events. The system of the present invention provides access to updated information at predetermined intervals, for example every 15 to 30 seconds. The information provided to the fan in attendance relates to the sporting event being attended as well as to other major sporting events happening at the same time.

The present invention illustratively provides a closed-network technology which creates only as large a wireless network as needed while limiting traditional concerns such as packet collisions, download delays and dropped packets.

Using the power of a personal digital accessory (“PDA”) (such as a Palm or IPAQ device), a closed wireless Ethernet network, and Web-enabled servers, the present invention provides the fan in the stand with the power of the fan at home—and more. Updates are delivered directly to the PDA held by the fan. The present invention permits a fan to access an Ethernet network via a wireless device at full network speeds.

Known as WiFi or IEEE 802.11, industry standards dictate how the wireless network operates. Those standards continue to evolve, but 802.11b is now considered the most stable, extensible and least expensive option. Today, access point hubs and routers are illustratively capable of 1 megabit transmissions up to 1,000 feet and 2,048 users.

The captive audience network system of the present invention illustratively includes a central Web server or servers at a central location. The server is connected via a high speed access to a router on site, which feeds antennas and bridges to an access point router. The routers send data to the handheld devices. One embodiment of the present invention transmits pre-determined information to each device at 15 to 30 second intervals. The user receives updates automatically. While the user's experience is similar to using a Web site, there are typically few requests back to the server, only navigation via a custom software package and streaming content. Additional servers can be added as needed based on demand.

The data streams (updates, scores, statistics, times, leaderboards, etc.) are already being delivered to the Internet for league or association Web sites from third party content providers. This data is compiled in real time at the central server location and then fed to the captive audience networks at each event in progress.

PDA Rental and Logistics

Devices will be rented two ways: 1) Via a Web site to pre-order the device and have it reserved at the event; and 2) Via walk-up rentals at the event in booths operated by vendors trained in use of the device. In each case, users use a credit card, smart card or other fee charging device and complete a rental form at the event location.

Each PDA device has a unique bar code or other identification member that is linked to the unique credit-card number of such user. Upon approval of the credit card, a receipt is printed that includes a personal identification number (PIN). The PIN works only with the corresponding PDA device. Any attempt to use that PIN with another PDA device will fail.

The PDA device will only work within the confines of the arena or facility. The wireless network has a limited range, and cannot be used outside the arena or facility (in limited cases, devices may work for up to 100 feet of the arena or facility). Also, the devices are loaded with only the basic software needed for the system of the present invention. The rubberized case illustratively precludes the user from being able to alter the software without doing permanent damage to the device. In essence, the device is worthless outside its intended use and has no value to the user upon completion of the event.

Upon completion of the event, the device is returned to booths at the exits of the facility. Again, a bar-code scanner or other input device is utilized to register the return. Another receipt is issued that should be kept by the users as proof of return. In the event the device is not returned or damaged, the user's credit card is charged the full price of the device.

Additional features of the invention will become apparent to those skilled in the art upon consideration of the following detailed description of illustrated embodiments exemplifying the best mode of carrying out the invention as presently perceived.

### BRIEF DESCRIPTION OF DRAWINGS

The detailed description particularly refers to the accompanying drawings in which:

FIG. 1 is a block diagram illustrating the hardware components of the present invention;

FIG. 2 is a perspective view of an illustrated example of a personal digital assistant (“PDA”) used in the system of the present invention;

FIG. 3 is a flow chart illustrating the steps performed during rental of a PDA at an event;

FIG. 4 is a flow chart illustrating the steps for operation of the PDA during the event;

FIG. 5 is a flow chart of the steps performed to set preferences for the PDA;

FIG. 6 is a flow chart of the steps performed for ordering products using the PDA at the event; and

FIG. 7 is a flow chart illustrating steps of a survey feature of the present invention.

### DETAILED DESCRIPTION OF THE DRAWINGS

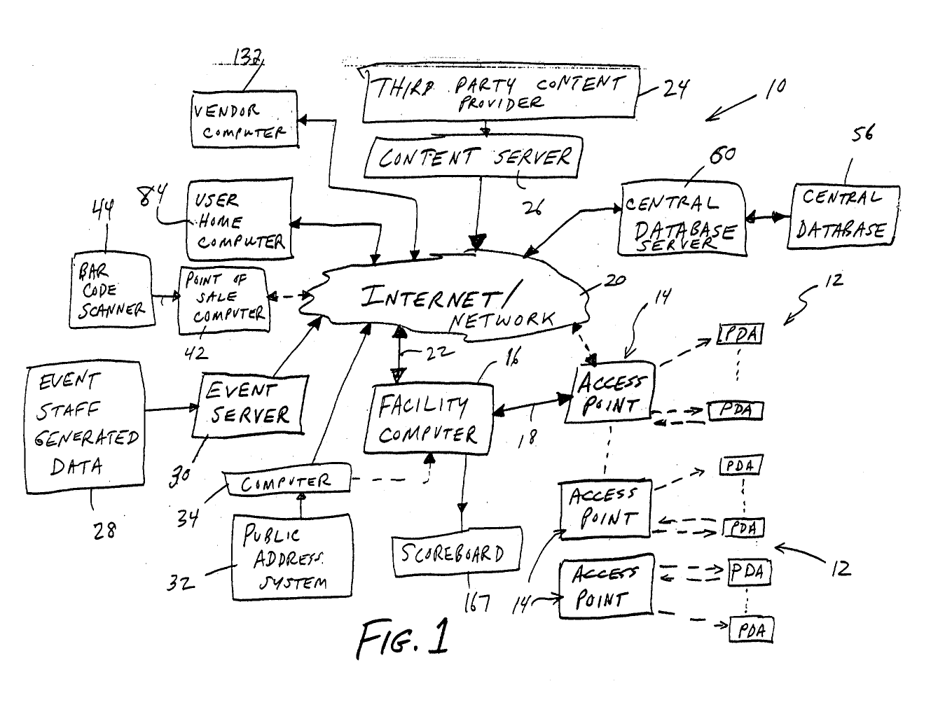

A system and method are provided for providing information data to a plurality of users in a captive audience using a wireless network. FIG. 1 illustrates hardware components of a system 10 of the present invention. Each user of the system 10 has a personal digital assistant, or PDA, 12 which is configured to store a plurality of data sets in a memory of the PDA 12 and display information for the user. The present invention is particularly suited for users in a captive audience, such as a live sporting event or other similar event. Information is illustratively transmitted to the PDAs 12 through a plurality of access points 14 which transmit information to PDAs 12 and receive information from PDAs 12. Illustratively, the PDAs 12 are hand-held Palm™ PDAs available from Palm, Inc. It is understood, however, that other portable data storage units may also be used which are capable of receiving, storing, and displaying data and which are optionally capable of editing and transmitting data back to the access points 14.

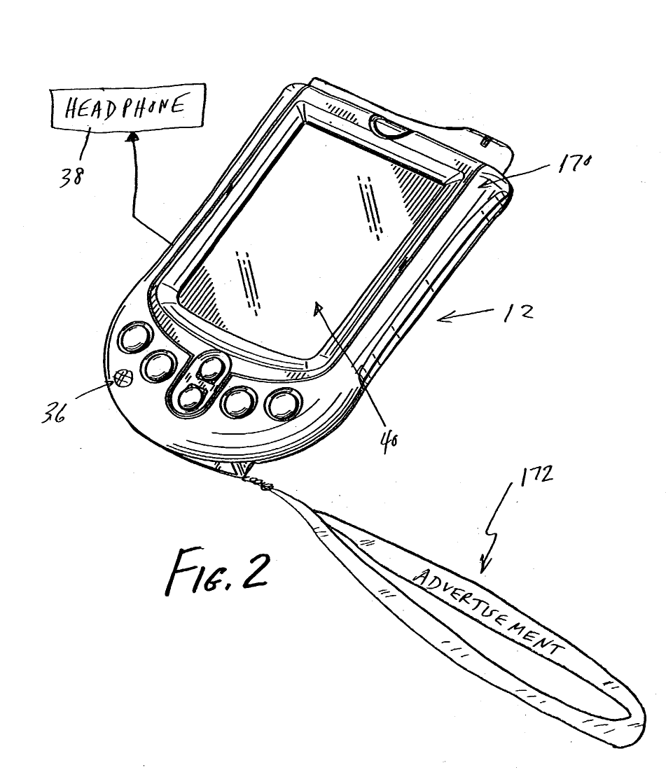

An illustrated PDA 12 of the present invention, shown in FIG. 2, includes a display 40 which may either be a monochrome screen because of its clarity in bright sunlight or a color screen. The PDA operating system may be a Palm OS, a WinCE system, a Linux-based system, or other suitable operating system.

PDA 12 is illustratively encased in a rubberized cover that contains a 802.11b wireless adaptor and extra battery power. Because the average sporting event lasts only about 3.5 hours, battery life is not a major concern. The rubberized cover is illustratively attached to a lanyard 172 at the bottom of the device. A stylus (not shown) is attached to the rubberized case via a nylon string or other coupler. The lanyard 172 is illustratively hooked to the rubberized case with a traditional locking device. A clear pocket (not shown) is formed in the back of the rubberized case for easy storage of an event ticket. Users may be allowed to keep the lanyard at the end of the event.

The PDA 12 is a handheld device that combines computing communication, and networking features. The PDA may include a pen-based input using a stylus, a keyboard for input, a voice input by using voice recognition technologies, or other type of user input device.

In other embodiments of the present invention the PDA 12 includes:

Full color display.

Real-time full-motion video display and personalized replay.

Full sound.

Interactive ordering and purchasing.

Personalized preferences that can be used at any location based on login.

Real-time crowd polling with results displayed on scoreboard screens.

A number of different industry standards for radio specifications exist. These radio specifications include, for example, the specification of Bluetooth Special Interest Group, referred to by the trade name Bluetooth, or the specification of the Institute of Electrical and Electronics Engineers Incorporated, referred to as 802.11. In addition to the industry standards for radio specifications, a number of design criteria mandated by various regulatory agencies, such as the Federal Aviation Administration, also exist.

802.11 refers to a family of specifications developed by the IEEE for wireless LAN technology. 802.11 specifies an over-the-air interface between a wireless client and a base station or between two wireless clients. The IEEE accepted the specification in 1997.

There are several specifications in the 802.11 family:

1. 802.11—applies to wireless LANs and provides 1 or 2 Mbps transmission in the 2.4 GHz band using either frequency hopping spread spectrum (FHSS) or direct sequence spread spectrum (DSSS).

2. 802.11a—an extension to 802.11 that applies to wireless LANs and provides up to 54 Mbps in the 5 GHz band. 802.11a uses an orthogonal frequency division multiplexing encoding scheme rather than FHSS or DSSS.

3. 802.11b (also referred to as 802.11 High Rate or Wi-Fi)—an extension to 802.11 that applies to wireless LANS and provides 11 Mbps transmission (with a fallback to 5.5, 2 and 1 Mbps) in the 2.4 GHz band. 802.11b uses only DSSS. 802.11b was a 1999 ratification to the original 802.11 standard, allowing wireless functionality comparable to Ethernet.

4. 802.11g—applies to wireless LANs and provides 20+ Mbps in the 2.4 GHz band.

The access points 14 provide a hardware device and computer software that acts as a communication hub for users of a wireless device to connect to a wired LAN. Access points 14 are important for providing heightened wireless security and for extending the physical range of service a wireless user has access to. Illustratively, access points 14 are AIRONET™ access points available from Cisco. It is understood that other access points may be used, if desired. The access points 14 provide a wireless LAN for the facility in which they are installed. Illustratively, the access points 14 are IEEE 802.11b compliant.

Illustratively, each access point 14 includes a transmitter and a receiver. Therefore, each access point 14 can transmit data to a plurality of PDAs 12 within range of the particular access point 14. In addition, each access point 14 transmits the data to the next adjacent access point 14. Each access point 14 also includes a receiver to receive information from adjacent access points 14 and from PDAs 12. Illustratively, the first access point 14 is hard wired to a facility computer 16 illustrated by connection 18. Alternatively, the first access point 14 may be directly coupled to a local or wide area network 20. One example of a network 20 is the Internet or any other intranet.

The PDAs 12 are programmed so that they will only work with the wireless network set up at the event. Custom software on the PDAs 12 and routing systems will provide a gateway that can only be used with proper identification and authorization. The PDA 12 software will communicate its unique identification to the routing system, which will authorize the PDA 12 for use on the closed network. Only PDA 12 devices programmed with this software will be authenticated.

Illustratively, information is routed to the access points 14 and distributed to PDAs 12 from a plurality of sources. The facility computer 16 is programmed to determine the information that is distributed to the access points 14 via connection 18 for transmission to the PDAs 12. Facility computer 16 is coupled to network 20 by connection 22. Therefore, facility computer 16 can transmit and receive information to and from other components coupled to the network 20. The facility computer 16 receives information from a plurality of third party content providers 24 via content servers 26 which are coupled to network 20. For instance, ESPN.com provides information related to news, scores, standings and rankings of sporting events. As an example, ESPN's BottomLine or SportsTicker information may be transmitted to the PDAs 12, if desired.

In addition, information can be created at the live event by an on-site staff as illustrated at block 28. This information is illustratively fed through an event server 30 to network 20 for retrieval by facility computer 16. Alternatively, event server 30 can be coupled directly to facility computer 16 by a wired or wireless connection.

The present invention also permits information from the public address system 32 at the event attended by users or at another event to be transmitted to the PDAs 12. Illustratively, public address system 32 is coupled to computer 34 which converts the public address output from an audio signal to a digital signal. Computer 34 is coupled to network 20 so that the public address information is transmitted to facility computer 16 via the network 20. Alternatively, computer 34 is coupled directly to the facility computer 16.

Computer 20 provides audio signals to the facility computer 16 for distribution to the PDAs 12. A captioning service or voice recognition software may also create a text transcript of the public address broadcast. PDA 12 includes a speaker 36 or preferably an audio head phone 38 connected to the PDA so that the user can hear the public address system audio information received through the PDA 12. This feature is particularly helpful at events such as auto racing when it is often difficult to hear the public address system 32. The PDA 12 can also be used to provide audio from public address systems at remote sporting events. Therefore, if the user wants to listen to the call of a horse race occurring at a remote location, for example, the public address system information is transmitted via network 20 to facility computer 16, through access points 14, and the PDA 12. Text captioning information may be displayed on screen 40 for viewing by the user.

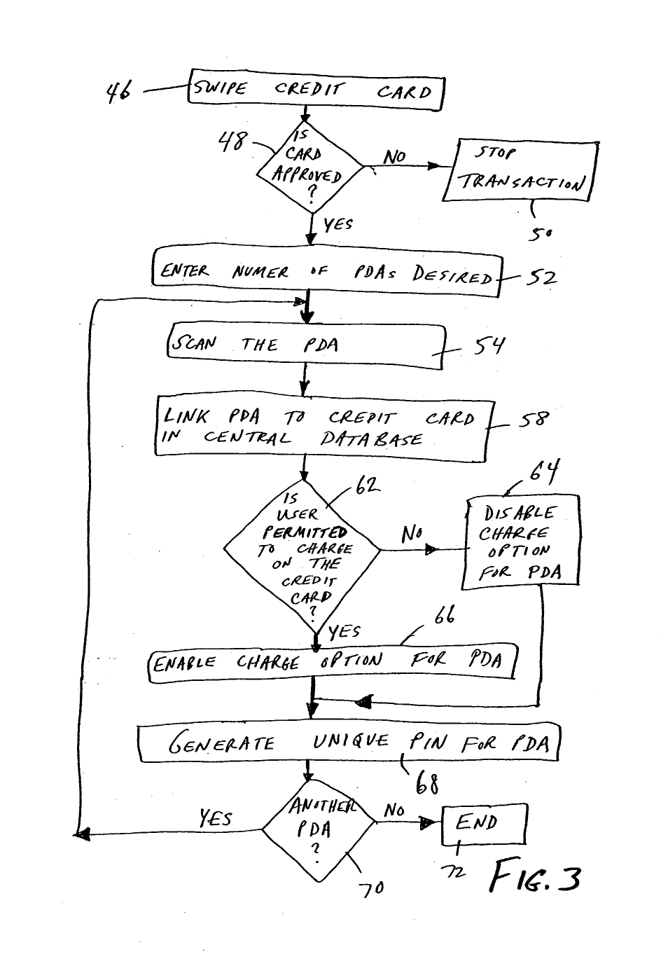

In the business method of the present invention, the PDAs 12 are rented to users at the event. FIG. 3 illustrates the steps performed during the rental process. Illustratively, the rental process is formed using a point of sale computer 42 shown in FIG. 1 which is illustratively coupled to a bar code scanner 44. Although a bar code scanner 44 is preferred, other types of scanning devices may be used to identify the PDA being rented. For instance, IR, RF, magnetic stripe readers, or optical scanners may be used in accordance with the present invention.

Referring to FIG. 3, an operator first swipes the credit card of the user as illustrated at block 46. Point of sale computer 42 is coupled to network 20 to access data bases coupled to the network 20. Computer 42 checks for approval of the credit card in a conventional manner as illustrated at block 48. If the card is not approved, the transaction is ended as illustrated at block 50. If the card is approved at block 48, the operator enters the desired number of PDAs 12 to be rented as illustrated at block 52. In other words, a single person may want to rent PDAs for multiple people. The first PDA 12 is then scanned using the bar code scanner 44 or other input device as illustrated at block 54. Each PDA 12 includes its own unique serial number. The bar code or other information carrying device is related to the unique serial number for the particular PDA 12. The particular PDA 12 is then linked to the credit card in a central database 56 as illustrated at block 58. Central database 56 includes information related to all the PDAs. Central database 56 is coupled to network 20 by a central database server 60.

Next, the operator determines whether the user of the particular PDA 12 is permitted to charge on the credit card during the event as illustrated at block 62. If not, the charge option is disabled for the particular PDA 12 as illustrated at block 64. If the user is permitted to charge on the credit card using the particular PDA 12, the charge option is enabled for the particular PDA 12 as illustrated at block 66. Next, computer 42 generates a unique personal identification number (PIN ) for the PDA 12 at block 68. Unique PIN must be entered into the PDA 12 before the PDA becomes operable. Next, computer 42 determines whether another PDA is to be rented by the same credit card at block 70. If not, the transaction is ended at block 72. If another PDA is to be rented, computer 42 returns to block 64 to prompt scanning of the next PDA 12.

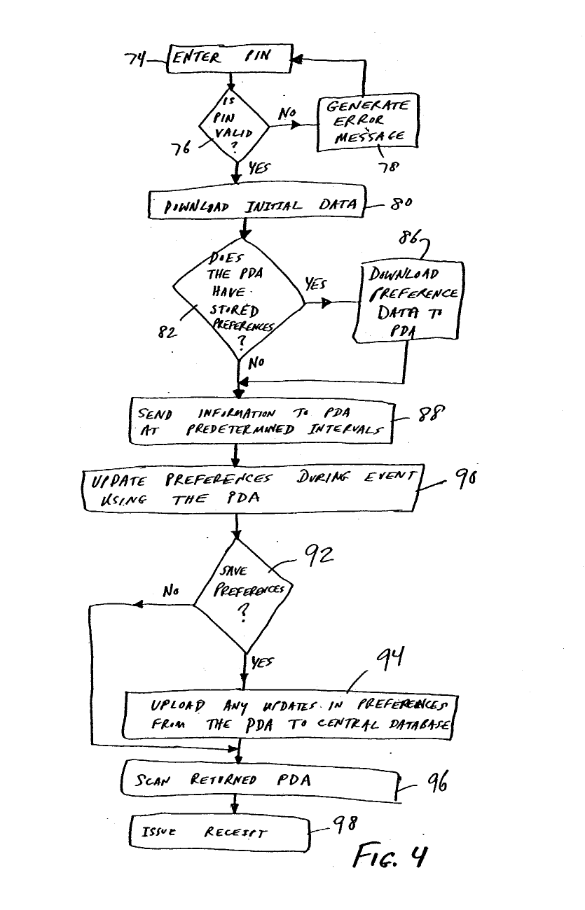

Operation of the PDA 12 during the event is best illustrated in FIG. 4. First, the user enters the unique PIN for the PDA 12 which was generated at block 68 as illustrated at block 74. A determination is then made whether the PIN is valid at block 76. If not, PDA 12 generates an error message at block 78 and returns to prompt entry of the PIN at block 74. If the PIN is valid at block 76, initial data is downloaded to the PDA from an access point 14 at block 80. Facility computer 16 next determines that the PDA 12 is operative and then determines whether the particular PDA 12 has any stored preferences within database 56 as illustrated at block 82. As discussed further below, the stored preferences may be established prior to an event by the user using his own home computer 84 or established by the user during an event using the PDA 12. Step 82 may be accomplished using a login screen and password. If the particular PDA 12 has stored preferences, the stored preference data is downloaded to the PDA 12 from central database 56 as illustrated by block 86. Next, the PDA 12 receives information from the access points 14 at predetermined intervals during the event. Therefore, as discussed above, the user is provided with updated information throughout the event. This step is illustrated at block 88.

In one illustrated embodiment, the user is able to update preferences during the event using input devices on the PDA 12 as illustrated at block 90. The user is given the option to save the preferences which were updated during the event by a prompt on display 40 as illustrated at block 92. Therefore, the user can save the preferences to be used the next time a PDA 12 is rented. If the user wants to save his updated preferences at block 92, updates to the preferences are uploaded from the PDA 12 and stored in central database 56. This step is illustrated at block 94. If the user does not wish to save updated preferences at block 92, the updates are not uploaded.

When the event is concluded, the PDA 12 is scanned again using bar code scanner 44 or other input devices as it is returned as illustrated at block 96. A receipt is then issued at block 98 which shows the charge for the PDA rental and/or other charges made during the event using the PDAs 12. If a PDA 12 is not returned, the credit card of the renter for the particular PDA 12 is charged for the full value of the PDA 12, not just the rental fee.

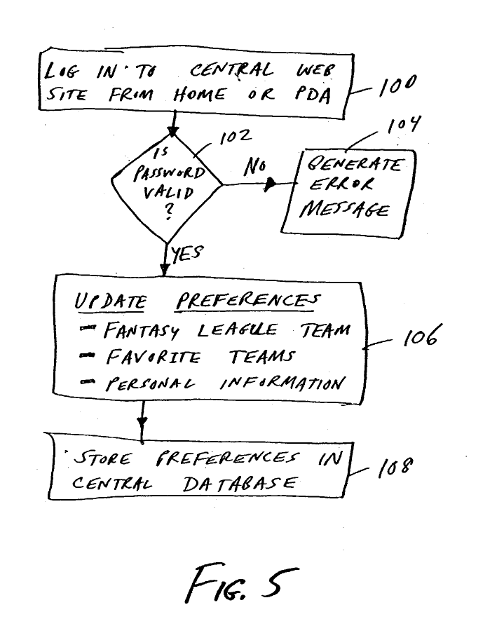

As discussed above, users can also set up preferences for the PDA 12 prior to an event from a remote computer 84. By using a login name and password, the user can access his personal account as illustrated at block 100 in FIG. 5. Also, as discussed above, this update may be accomplished using the PDA 12 during an event. It is first determined whether a password entered by the user is valid at block 102. If not, an error message is generated as illustrated at block 104. If the password is valid, the user is permitted to update preferences stored in central database 56. The user may be provided with a menu of options to add to the preferences. For instance, the user can set up a fantasy league team in various sports, make settings for favorite sports, leagues, divisions, or teams, or provide settings to receive the latest news, as well as game and sports. The user can also customize personal information such as name, address, credit card information, or other information stored in the central database 56. This step is illustrated at block 106. The updated preferences are then stored in central database 56 as illustrated at block 108.

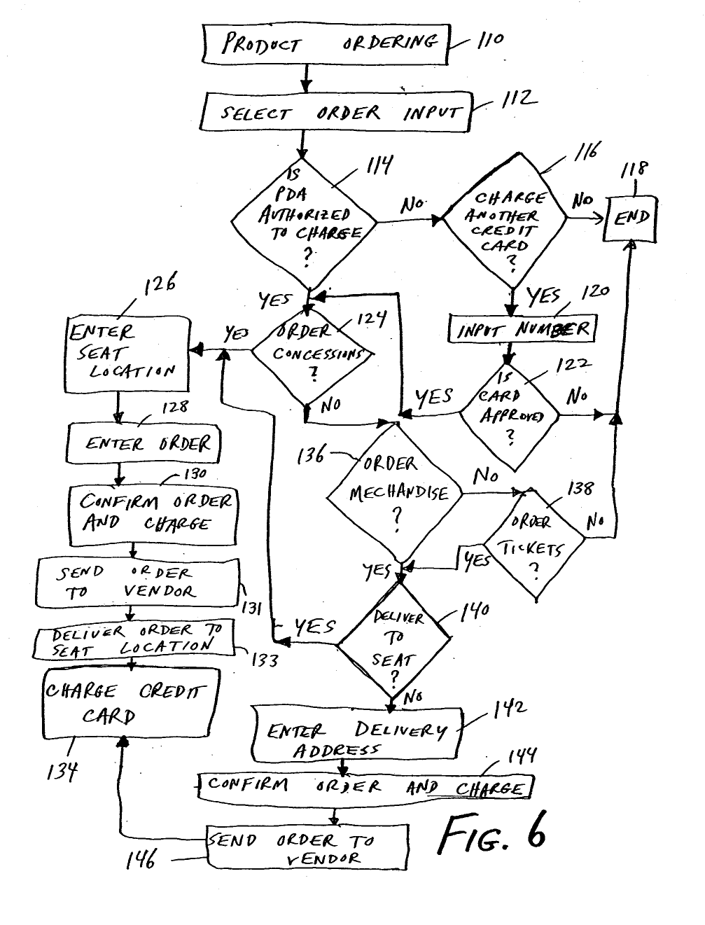

Details regarding ordering products using in the PDAs 12 are illustrated in FIG. 6. The product ordering function begins at block 110. The user first selects an input on PDA 12 indicating a desire to place an order as illustrated at block 112. Facility computer 16 then determines whether or not the particular PDA 12 is authorized to charge corresponding credit card as illustrated at block 114. This information is obtained from central database 56. If a charge option has not been previously authorized or enabled, a prompt is given to allow the user to use another credit card as illustrated at block 116. If the user does not want to use another credit card, the transaction ends as illustrated at block 118. If the user desires to user another credit card, the user inputs the credit card number as illustrated at block 120. Facility computer 16 determines whether or not the new credit card is approved using conventional techniques as illustrated at block 122. If the card is not approved, the transaction ends. If the card is approved, the user is prompted to determine whether the user wants to order concessions, merchandise or tickets.

Facility computer 16 determines whether the user wants to order concessions as illustrated at block 124. If the user wants to order concessions, the user is prompted to enter his seat location as illustrated at block 126. The user uses an input on PDA 12 to enter the seat location. A normal seat location can be saved and used by the system. Next, the user enters the order using the input on the PDA as illustrated at block 128. After the order is complete, the user is prompted to confirm the order and charge as illustrated at block 130. Facility computer 16 transmits the order to a vendor computer 132 coupled to network 20 as illustrated at block 131. The vendor in this instance is a concession vendor within the event location. Next, the vendor delivers the concessions to the user by seat location as indicated at block 133. The credit card associated with the PDA 12 is then charged as illustrated at block 134.

If the user does not want to order concessions at block 124, the computer 16 determines whether the user wants to order merchandise at block 136. If the user does not want to order merchandise, computer 16 determines whether or not the user wants to order tickets as illustrated at block 138. If the user does not want to order tickets, the transaction ends.

If the user wants to order merchandise or tickets at blocks 136 or 138, respectively, the computer 16 determines whether the user wants the merchandise or tickets delivered to his seat at the event as illustrated at block 140. If so, computer 16 advances to block 126 to obtain the seat location, order entry, and delivery of the merchandise or tickets to the user's seat as discussed above. If the user does not want the merchandise or tickets delivered to his seat, or if the merchandise or tickets are not available to be delivered, the user is prompted to enter the desired address for delivery as illustrated at block 142. The desired delivery address may be stored in central database 56. Therefore, the user can select the previously stored address or enter a different address for delivery of the merchandise or tickets. The user is then prompted to confirm the order and the charge amount for the merchandise or tickets being purchased as illustrated at block 144. The order is then sent to the appropriate vendor as illustrated at block 146 for delivery to the selected address. The associated credit card is then charged as illustrated at block 134.

Another option available instead of seat delivery or home delivery is that the concession, merchandise, or ticket order can be held at vendor location for pick up by the user at a later date. If the location is the same location as the event, the PDA 12 can be sent a notification when the order is read for pick up.

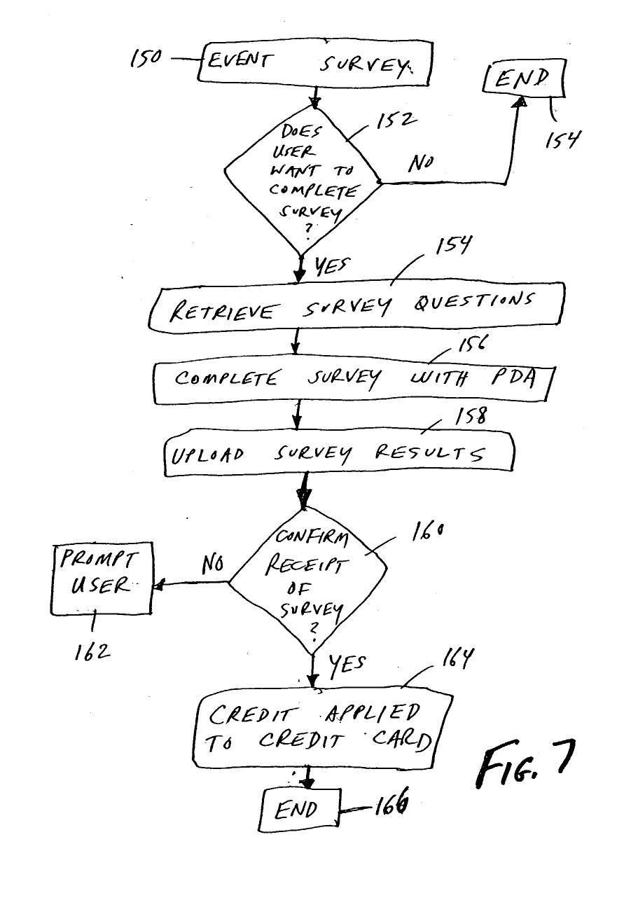

The steps performed during completion of a survey by the user are illustrated in FIG. 7. At many events, surveys are taken regarding various topics. Typically, these survey results are manually taken by employees. The event survey begins at block 150. The user is prompted to inquire whether or not the user wants to participate in the survey as illustrated at block 152. If not, the survey ends at block 154. If the user wants to complete the survey, the survey questions are retrieved as illustrated at block 154. The survey questions can be initially stored in the PDA 12, or downloaded to the PDA 12 during the initial download of information discussed above at block 80. The user then completes the survey using an input device on the PDA as illustrated at block 156. After the survey is complete, the survey results are uploaded from the PDA 12 to the facility computer 16 as illustrated at block 158. Facility computer 16 confirms receipt of the survey results at block 160. If the survey results are not received, computer 16 prompts the user to resend the survey information as illustrated at block 162. If the survey results are received, computer 16 acknowledges receipt of the results. An optional feature is that the credit card associated with particular PDA 12 may be credited a certain amount based on the received survey illustrated at block 164. This credit will encourage users to complete the survey. The survey process then ends at block 166. The survey results or other information can be linked to and displayed on a scoreboard 167 at the event.

Referring again to FIG. 2, in the business method of the present invention, advertising space is sold on the outer housing 170 of PDA 12. In addition, advertising is sold on the lanyard or strap 172 coupled to the PDA 12. Advertisements can also be sold which are displayed on display screen 40. The display 42 typically displays an initial screen and then second, third, fourth level screens depending upon options selected by the user. Ads may be sold for the initial screen, second screen, third screen, etc. at different rates.

Also in the business method of the present invention, other revenue sources include:

Rental fees for the PDA devices

Naming rights to the device (for example, the ESPN StatCaster).

Advertising on display screen of the device (see below).

Branding on handheld device and lanyard.

Audience Surveys through handheld PDA.

Retailer rebate partnering programs where handheld PDA vendor partner would offer a $10 rebate on the purchase of the handheld device with presentation of a receipt for PDA device rented at am event.

Although the invention has been described in detail with reference to a certain illustrated embodiments, variations and modifications exist within the scope and spirit of the invention as described and as defined in the following claims.

What is claimed is:

1. A method for providing data to a plurality of people in a captive audience during an event, the method comprising:
providing a limited range wireless network;
renting a plurality of PDA devices to a plurality of people attending the event;
loading software into the plurality of PDA devices to permit the PDA devices to receive data from the wireless network;
transmitting data to the plurality of rented PDA devices from the wireless network during the event; and
collecting the plurality of PDA devices after the event.

2. The method of claim 1, further comprising:
permitting each user of a PDA device to update a plurality of user preferences related to the data to be received from the wireless network; and
storing the user-selected preferences in a central database coupled to the wireless network.

3. The method of claim 1, wherein the collecting step comprises:
obtaining an identification number from each returned PDA after completion of the event;
issuing a receipt for charges incurred by a user of the PDA during the event; and
charging the user's credit card for charges incurred by the user during the event.

4. The method of claim 1, wherein the renting step comprises:
obtaining credit card information from each user of a PDA;
obtaining a serial number for the PDA;
associating the PDA serial number to the user's credit card;
storing the associated information in a central database; and
generating a unique personal identification number for the PDA which is required to activate the PDA.

5. The method of claim 4, further comprising:
determining whether the user is permitted to charge the associated credit card using the PDA;
disabling a charge option for the PDA if the user is not permitted to charge on the credit card; and
enabling the charge option if the user is permitted to charge on the credit card; and
storing an indication related to the charge option status in the central database.

6. The method of claim 4, further comprising steps of:
entering the unique personal identification number in the PDA;
determining whether the personal identification number is valid; and
downloading initial data to the PDA via the wireless network only if the personal identification number is valid.

7. The method of claim 1, further comprising:
determining if the PDA has any associated user-selected preferences stored in a central database; and
downloading any user-selected stored preferences from the central database to the PDA via the wireless network.

8. The method of claim 7, further comprising updating the user-selected preferences by connecting to the central database via a remote computer.

9. The method of claim 8, wherein the updating step comprises:
determining whether the user has a valid password;
updating the user-selected preferences if the password is valid, and
storing the updated user-selected in the central database.

10. The method of claim 8, wherein the updating step occurs using the PDA at the event.

11. The method of claim 1, further comprising:
placing a product order using the PDA at the event; and
delivering the ordered product to a selected location.

12. The method of claim 11, wherein the step of placing a product order comprises:
determining whether the PDA is authorized to make charges to an associated credit card during the event;
determining the type of product to be ordered;
obtaining a delivery address for the user;
confirming the order and charge to the associated credit card;
transmitting the order to a vendor;
charging the credit card; and
delivering the product to the delivery address.

13. The method of claim 12, wherein the delivery address is a particular seat location at the event.

14. The method of claims 12, wherein the delivery address is the user's home address.

15. The method of claim 1, further comprising:
determining whether the user wants to complete a survey using the PDA;
displaying survey questions on a display of the PDA;
completing the survey using the PDA; and
uploading survey results from the PDA to a central computer via the wireless network.

16. The method of claim 15, further comprising: checking for the receipt of the survey results from the PDA at the central computer;
applying a credit to a credit card associated with the PDA upon receipt of the survey results; and
prompting the user to resend the survey results if the receipt of the survey results are not received within a predetermined time.

17. The method of claim 1, further comprising the step of selling advertisements on the PDA device.

18. The method of claim 17, wherein the advertisements are located on at least one of a housing of the PDA device, a lanyard coupled to the PDA device, and a display screen of the PDA device.

19. The method of claim 17, wherein the PDA device includes an initial display screen and a plurality of subsequent display screens, the method further comprising the step of selling advertisements on the initial display screen and on at least one of the plurality of subsequent display screens.

20. The method of claim 1, further comprising:
delivering information from a public address system to the PDA via the wireless network.

21. The method of claim 20, wherein the public address information is an audio signal.

22. The method of claim 20, wherein the public address information is a captioned transcript of a public address broadcast.

23. The method of claim 20, wherein the public address information originates at a location remote from a facility hosting the event.

24. The method of claim 1, further comprising:
determining which of the rented PDA devices were not received during the collecting step; and
charging an associated credit card for any unreturned PDAs.

25. The method of claim 1, wherein the step of providing a limited range wireless network includes providing a plurality of wireless data access points at various locations within a facility hosting the event, the access points configured to transmit and receive data to and from the PDA devices and to and from adjacent access points.

26. The method of claim 1, wherein the data transmitted over the wireless network is received from a plurality of third party content providers via a communication network coupled to the wireless network.

27. The method of claim 1, wherein the data transmitted over the wireless network is generated at the event.

28. The method of claim 1, wherein the loading step occurs before the renting step.

29. The method of claim 1, wherein the loading step occurs after the renting step.
